(19) United States
(12) Patent Application Publication
(10) Pub. No.: US 2006/0207266 A1
(43) Pub. Date: Sep. 21, 2006

(54) Assembly providing a tubular electrical conductor in thermal contact but electrical isolation with a thermal link

(75) Inventors: Neil John Belton, Didcot (GB); Raymond Hornsby, Witney (GB); Patrick Graham Sorsby, Cassington (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Oxon (GB)

(21) Appl. No.: 11/346,342

(22) Filed: Feb. 3, 2006

(30) Foreign Application Priority Data
Feb. 5, 2005 (GB) 0502457.5

(51) Int. Cl. F17C 5/02; F25B 19/00

(52) U.S. Cl. 62/51.1; 62/47.1

(57) ABSTRACT

The present invention provides an improved joint between a thermal link and a tubular electrical conductor within a turret used in a cryostat. The joint is thermally conductive yet electrically isolating, cheap and simple to produce, and offers superior electrical isolation.

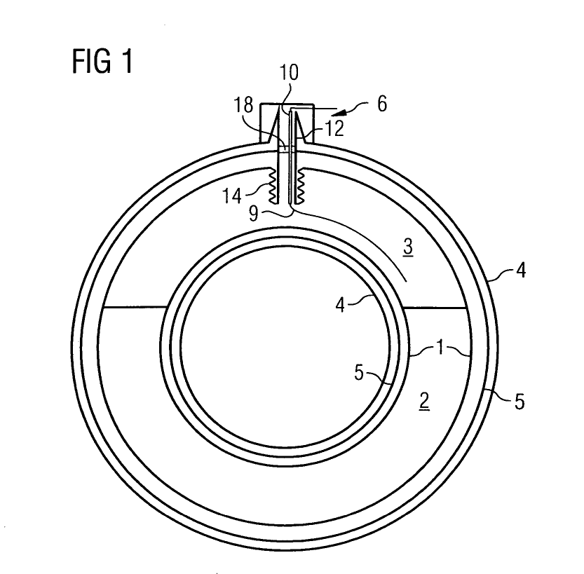

FIG. 1 shows a cryostat such as may be employed for holding magnet coils for an MRI (magnetic resonance imaging) system. A cryogen vessel 1 holds a liquid cryogen 2. The space 3 in the cryogenic vessel above the level of the liquid cryogen may be filled with evaporated cryogen. The cryogen vessel is contained in a vacuum jacket 4 which serves to reduce the amount of heat flowing to the cryogen 2 from ambient temperature, by reducing the possibility of conduction or convection heating of the cryogen vessel 1. One or more heat shields 5 may be provided in the vacuum space between the cryogen vessel 1 and the vacuum jacket 4. These shields serve to reduce the amount of radiated heat reaching the cryogen vessel 1 from the exterior. An access neck 6 is provided, allowing access to the cryogenic vessel from the exterior. This is used to fill the cryogen vessel, to provide access for current leads and other connections to superconductive coils housed within the cryogen vessel, and to allow an escape path for boiled-off gaseous cryogen.

In order to introduce electrical current into the magnet coils, two electrical connections must be made to the coils. Typically, these are positive and negative DC connections. The negative connection is typically made through the body of the cryostat, while the positive connection is made through a tubular electrical conductor 10, commonly referred to as a positive tube, shown in FIG. 1. The positive tube must be electrically isolated from electrically conductive parts of the cryostat Positive tube 10, typically a thin walled stainless steel electrically conductive tube, passes into the cryogen vessel. An electrical lead 9 connects the positive tube to equipment, such as superconducting coils (not shown) for NMR or MRI magnets. The positive tube 10 is also connectable to a current source external to the cryostat, for introducing electrical current into equipment within the cryogen. The positive tube 10 is typically connected to the positive terminal of the current source, with the negative current return path being provided through the structure of the cryostat. Since the positive tube 10 extends through the access neck 6, from the cryogen vessel 1 to the exterior, it provides a path for heat influx into the cryogen vessel. This problem is typically addressed by thermally linking the positive tube 10 to a cooled part, such as the thermal shield 5. In the illustrated cryostat, this is achieved by providing a thermal link 18, through which the positive tube passes, in thermal connection but electrical isolation. The thermal link provides thermal conduction between the positive tube 10 and the thermal shield 5. A passageway is provided in the thermal link 18 to provide access for other connections, for cryogen fill and to allow gaseous cryogen to escape in the event of a quench.

The positive tube 10 is typically housed within a turret 12, typically another thin walled stainless steel tube. A lower part of turret 12 may itself be housed within a bellows 14. In position, the bellows forms part of the cryogen vessel 1. The bellows 14 is typically a thin walled stainless steel tube of greater diameter than the positive tube 10 and the turret 12. The bellows accommodates a length of the turret 12 and the positive tube 10 extending down into the cryogen vessel 1. The extended length of the turret 12 and the positive tube 10 allowed by the bellows 14 increases their thermal path length and so helps to reduce thermal influx into the cryogen vessel. The bellows structure serves to accommodate differences in thermal expansion and other relative movement between the cryogen vessel 1, the thermal shield 5 and the outer vacuum chamber 4.

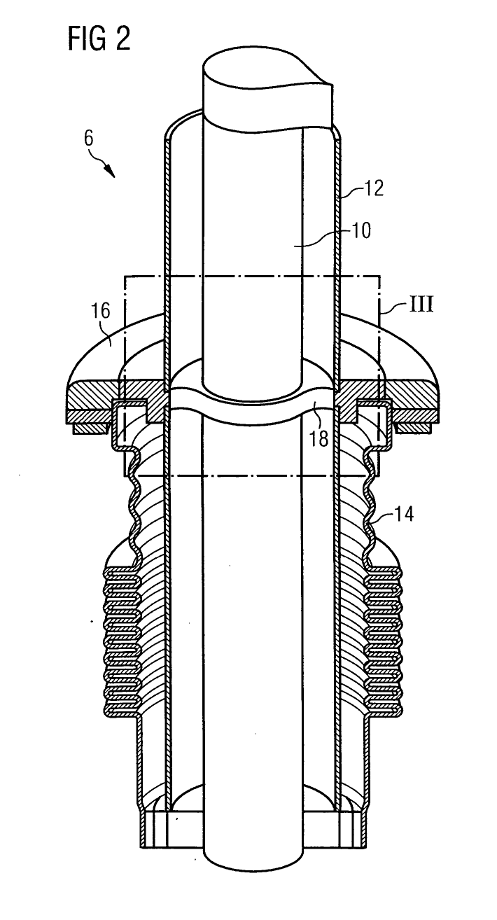

FIG. 2 illustrates a fixed positive tube access neck 6 according to the prior art. A positive tube 10, typically comprising a thin-walled stainless steel tube, functions as an electrical conductor for introducing electrical current into equipment within the cryogen vessel 1. Such equipment may typically be superconducting magnetic coils for an MRI system. The positive tube must be insulated from other electrically conductive components since the return path for the current is generally through the structure of the cryostat.

It is desired that the positive tube 10 be cooled by a refrigerator, typically to a temperature of the order of 50K. This serves to reduce the heat influx into the cryogen vessel 1, by removing heat flowing from ambient along the material of the positive tube 10 before it reaches the cryogen vessel 1.

As shown in FIG. 2, a thermal intercept 16 is provided, mechanically and thermally in contact with the turret 12. In a preferred embodiment, separate sections of turret 12 are bonded into suitably shaped channels within the thermal intercept 16, so that a single piece of thermally conductive material, typically copper, extends from the exterior of the turret 12 to its interior. This thermal intercept 16 is cooled by thermal conduction along a conductive path to a refrigerator. The refrigerator in question is typically the first stage of a two-stage recondensing refrigerator, which cools the thermal intercept 16 to approximately 50K.

In order to provide the required thermal cooling and electrical isolation for the positive tube 10, a thermal link 18 is provided, joining the interior surface of the turret 12 to the exterior surface of the positive tube 10. Thermal link 18 and thermal intercept 16 are typically a single copper block, with separate sections of turret 12 bonded into suitably shaped channels within the thermal intercept 16. Thermal link 18, in such an embodiment, simply refers to that part of the thermal intercept which is located within the turret 12. Thermal link 18 must also provide electrical isolation between the positive tube 10 and the turret 12. The thermal link 18 preferably also provides mechanical support to the positive tube 10. The thermal link is cooled, through the material of the turret 12, by thermal conduction to thermal intercept 16.

According to the prior art, these requirements have been met by the following process.

The positive tube 10, typically a stainless steel tube, is plasma sprayed with alumina, at least in a band around the tube in a region destined to contact the thermal link 18. The positive tube is then plasma sprayed with copper over at least part of the region which has been sprayed by alumina, at least in a band around the tube in a region destined to contact the thermal link 18. The resultant structure will then comprise, at least in a band around the tube in a region destined to contact the thermal link 18, a stainless steel tube coated in an electrically insulating layer of alumina, which in turn is coated in an electrically conductive layer of copper. The layers are strongly mechanically linked, and have thermal conductivity. The stainless steel of the positive tube 10 and the copper coating layer are however electrically isolated.

The thermal link 18 typically has an inner diameter slightly greater than the outer diameter of the copper and alumina coated positive tube. Although not clearly visible in FIG. 2, a kidney-shaped passage is provided through the thermal link 18 to allow the passage of other services, cryogen fill and escape of cryogen gas in the case of a quench.

The thermal link 18 is slid over the positive tube 10 to the appropriate position. The thermal link 18 and the positive tube 10 are then heated, at least in the appropriate regions, sufficiently to allow soft soldering of the joint between them. The thermal link 18 is soft soldered to the copper coating on the positive tube. The resultant electrical isolation has been measured at under 10MΩ at 100V.

This method has at least the following drawbacks. The plasma spraying processes are difficult and costly to perform. The alumina used for plasma spraying, and the resultant alumina layer on the positive tube, is moisture absorbent and so requires careful drying, handling and storage. Moisture in the alumina can cause electrical breakdown, leading to an electrical short circuit between the positive tube and the structure of the cryostat, which can render the part useless since it will no longer be possible to supply current to the equipment inside the cryogen vessel 1. For soldering, it is necessary to heat the thermal joint and the positive tube to beyond the melting point of the solder. This is a time consuming step and requires appropriate process equipment. Before solder is applied, a flux must be applied to clean and prepare the surfaces of the positive tube and the thermal link. The chemistry of the flux means that it may damage surrounding metals. Any residue left by the flux is typically washed off with water, wetting the alumina layer which must then be carefully dried.

The present invention accordingly aims to address at least some of the drawbacks of the prior art, while producing a structure which provides sufficient electrical, thermal and mechanical performance.

The present invention accordingly provides methods and apparatus as defined in the appended claims.

The above, and further, objects, characteristics and advantages of the present invention will become more apparent from the following description of certain embodiments thereof, given by way of examples only, in conjunction with the appended drawings, wherein:

FIG. 1 shows a cross-section of a typical cryostat, such as may be used to house superconducting magnets in MRI applications, and which could benefit from application of the present invention;

FIG. 2 shows a positive tube housed within a turret and thermally connected to a thermal intercept, according to the prior art; and

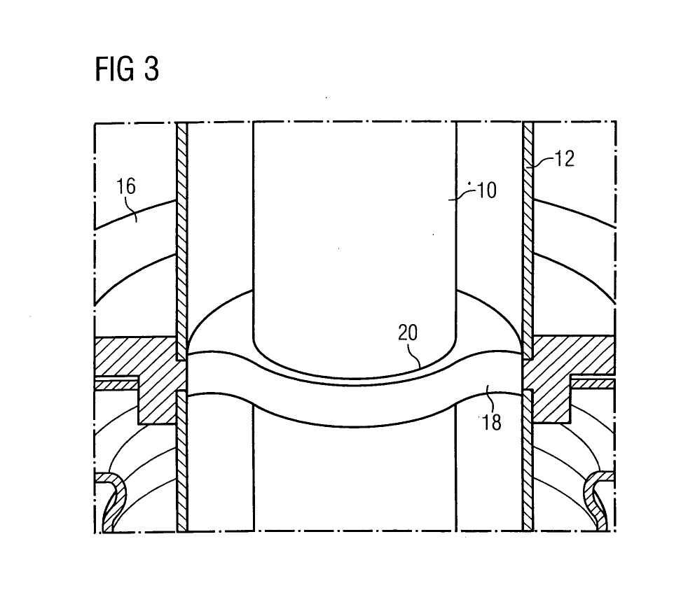

FIG. 3 shows a positive tube housed within a turret and thermally connected to a thermal intercept, according to an embodiment of the present invention.

FIG. 3 illustrates an enlarged detail of a fixed positive tube service turret according to an embodiment of the present invention. The part illustrated in FIG. 3 corresponds to the region III outlined in FIG. 2.

According to the present invention, the thermal link 18 is not soldered to the positive tube 10. Rather, according to the present invention, a thermally conductive yet electrically isolating mechanical joint 20 is made between the positive tube 10 and the thermal link 18 using an adhesive such as an epoxy resin. The adhesive in question must be thermally conductive, but electrically isolating.

In certain embodiments of the invention, the adhesive used is ECCOBOND® 285 epoxy resin or STYCAST® 2850FT epoxy resin, both available from Emerson & Cuming, 46 Manning Road, Billerica Mass., USA. The epoxy resin may be caused to harden by incorporation of Catalyst 9, or Catalyst 11, each available from Emerson & Cuming. The epoxy resin used is preferably filled with a highly thermally conductive, yet electrically isolating, filler. In certain embodiments, the filler may be a fine grained alumina (Al₂O₃) powder.

The combination of ECCOBOND® 285 epoxy resin with Catalyst 9 is known to provide a thermal conductivity of 1.3 W m⁻¹K⁻¹, and a volume resistivity of 10¹⁵ Ω cm at a temperature of about 300K. Another useful property of ECCOBOND® 285 epoxy resin in this application is its relatively low coefficient of thermal expansion, quoted by the manufacturer as 10⁻⁶ K⁻¹. Such epoxy resin adhesives have been found by the inventors to be tolerant of operating at temperatures of around 50K, as required for use in the present application in MRI systems cooled by liquid helium cryogen.

In alternative embodiments, adhesives other than epoxy resins may be used. For example, silicone or polyurethane adhesives may be used, preferably with thermally conductive but electrically isolating fillers such as alumina powder. Whatever adhesive is used, it must have the required properties of high thermal conductivity, high electrical resistance and tolerance of temperatures in the region of interest, for example about 50K.

ECCOBOND® and STYCAST® are registered trademarks of the National Starch and Chemical Company.

In order to form the adhesive joint 20 of the present invention between the positive tube and the thermal link 18, the following method may be employed.

A quantity of the selected adhesive is applied around the positive tube 10, covering at least a band around the positive tube in a location where the joint 20 to the thermal link will be made. The thermal link 18 is then slid over the positive tube to the appropriate position. The adhesive will be squeezed between the outer surface of the positive tube and the inner surface of the thermal link. It has been found that the adhesive effectively coats both of these surfaces. Any excess adhesive may be cleaned in a normal manner, such as by wiping with a cloth, if necessary. It may be found more effective to rotate the thermal link about the positive tube as it slides over the adhesive layer. This may assist the centring of the positive tube 10 within the thermal link 18. This process may be carried out at normal room temperature.

Since the adhesive is conformal to the surfaces being joined, the joint 20 according to the present invention is tolerant of a larger degree of deformation of the positive tube than is the case for the soldered joint of the prior art.

There is no need to apply a flux to the surfaces to be joined in the method of the present invention, avoiding the possibility of chemical damage to surrounding materials by such flux. There is no need to heat the positive tube and thermal link, as there was in the case of the soldered joint of the prior art.

The cost of forming the adhesive joint 20 between the positive tube 10 and the thermal link 18 according to the present invention is only about 10-20% of the cost of forming the soldered joint of the prior art.

The adhesives used to form the joint 20 according to the present invention do not absorb water to a significant degree. A moisture absorption of 0.1% after 24 hours at a temperature of 300 K is typical. Alumina, on the other hand, may absorb up to 50% moisture, and a corresponding figure for ‘dried’ alumina would be in the region of 10%.

The resultant electrical isolation provided by the joint 20 of the present invention between the positive tube and the thermal link has been measured at over 150 MΩ at 250V, which compares very favourably with the isolation of the soldered joint of the prior art, which had an electrical isolation measured at under 10 MΩ at 100V.

The thermal conductivity of the joint 20 of the present invention may be less than that of the soldered joint of the prior art. For example, a joint 20 of the present invention using STYCAST® 258FT has been measured to have a thermal conductivity of 0.46 Wm⁻¹K⁻¹, whereas a joint according to the prior art has been measured to have a thermal conductivity of 2.6 Wm⁻¹K⁻¹. The effect of this reduced thermal conductivity is expected to be a temperature rise of approximately 1K in the region of the joint 20. The inventors regard this degree of degradation of thermal conductivity as an acceptable price to pay for the other advantages offered by the joint 20 of the present invention. The inventors expect that further investigation by routine trial and error or another methods will identify filled adhesive materials which provide better thermal performance. The cited example of STYCAST® 258FT alumina-filled epoxy resin adhesive has previously been used in cryogenic applications, for example for attaching temperature measurement equipment into cryostats. It is accordingly known that such adhesive is reliable at the temperatures under consideration in the present application.

While the present application has been described with reference to a limited number of specific embodiments, various amendments and modifications may be made within the scope of the present invention as defined by the appended claims.

1. An assembly for incorporation within a turret (12) providing access to a cryogen vessel (1) of a cryostat, the assembly comprising:
a tubular electrical conductor (10); and
a thermally conductive thermal link (18) in thermal contact between an outer surface of the tubular electrical conductor and an inner surface of the turret (12), mechanically bonded to the tubular electrical conductor by a thermally conductive, electrically isolating layer of adhesive (20) formed between respective mating surfaces of the tubular electrical conductor and the thermal link.

2. An assembly according to claim 1 wherein the adhesive comprises a cured epoxy resin containing thermally conductive, electrically isolating filler.

3. An assembly according to claim 2 wherein the filler comprises particles of alumina Al₂O₃.

4. An assembly according to claim 1, wherein the tubular electrical conductor is substantially cylindrical, and the thermal link is annular, bonded around a part of the outer surface of the tubular electrical conductor.

5. A cryostat comprising a cryogen vessel (1) for containing a liquid cryogen (2) and a two-stage refrigerator for recondensing gaseous cryogen boiled off from the liquid cryogen, a turret (12) providing access to the cryogen vessel and housing an assembly according to claim 1, wherein a first stage of the two stage refrigerator is thermally connected to the thermal link (18).

6. A method for assembling a tubular electrical conductor (10) into a turret (12) in such a manner that the tubular electrical conductor is mechanically and thermally connected but electrically isolated from the turret by a thermal link (18), the method comprising the step of:
bonding the thermal link to a part of an outer surface of the tubular electrical conductor by way of a layer of adhesive (20).

7. A method according to claim 6, wherein the step of bonding the thermal link to a part of an outer surface of the tubular electrical conductor by way of a layer of adhesive itself comprises the steps of:
applying a layer of adhesive around the tubular electrical conductor (10), to cover at least a band around the tubular electrical conductor in a location where the bond to the thermal link will be made;
sliding the thermal link (18) over the tubular electrical conductor to the appropriate position, whereupon the adhesive will be squeezed between the outer surface of the tubular electrical conductor and the inner surface of the thermal link; and
curing the adhesive.

8. A method according to claim 7 wherein the tubular electrical conductor is substantially cylindrical and the thermal link is substantially annular and the thermal link is rotated about the tubular electrical
conductor as it slides over the adhesive layer.
